(19) United States
(12) Patent Application Publication
(10) Pub. No.: US 2002/0117343 A1
(43) Pub. Date: Aug. 29, 2002

(54) Motorized scooter

(75) Inventor: David Kao, Taoyuan Hsien (TW)

Correspondence Address: Jackson Walker L.L.P., Suite 2100, 112 E. Pecan Street, San Antonio, TX, 78205, US

(73) Assignee: Doryoku Technical Corp.

(21) Appl. No.: 09/794,295

(22) Filed: Feb. 27, 2001

(51) Int. Cl. B62D 61/02; B62K 11/00

(52) U.S. Cl. 180/220; 180/65.1

(57) ABSTRACT

A motorized scooter includes a platform (20), a steering column (10) pivotally secured to a front of the platform (20), a front wheel (12) mounted to the steering column (10), a rear wheel (14) mounted to the rear of the platform (20), a power train (30) extending between the platform (20) and the rear wheel (14) and a motor (32). The power train (30) has a driving sprocket (34), a driven sprocket (38), a chain (36) reeved around the driving and driven sprockets (34, 38), and a bracket (39) supporting the axle (322) and the driving sprocket (34). A freewheel mechanism (342) is fitted in the driving sprocket (34) whereby in a driving mode the turning axle (322) indirectly turns the rear wheel (14), and in a freewheel mode the turning rear wheel (14) does not result in the turning of the motor (32).

### BACKGROUND OF THE INVENTION

1. Field of the Invention

The present invention is related to a motorized scooter, and more particularly to a motorized scooter in which drive between a motor and a rear wheel is secure in a first direction of rotation, and released in a second direction of rotation.

2. Description of Related Art

Foot scooters have become very popular in recent years because they provide a very convenient method of transport and source of enjoyment for the riders. The convenience in folding such scooters when they are not being used of course provides a great advantage over bicycles and other common forms of vehicle. A further improvement of the foot scooter is the addition of a motor to increase the general speed of the scooter and thus reduce fatigue a rider may experience. The motor also enables a rider to keep up with slowly-moving traffic such as in a city, and the freedom from having to keep using a leg to propel the scooter results in both greater stability and clearer concentration on road safety.

One motorized prior art scooter is shown in FIG. 3, and comprises a steering column (60), a front wheel (62) attached to a bottom of the steering column (60), a platform (64) to a front of which the steering column (60) is pivotally mounted, a rear wheel (78) attached to a rear of the platform (64), a motor (66) disposed at a front portion of the platform (64) and a belt (72) linking the motor (66) and the rear wheel (78). The motor (66) has an axle (68) with a small diameter driving sprocket (70) secured to the axle (68), and the rear wheel (78) has a large diameter driven sprocket (74) drivingly secured thereto. In operation, the driving sprocket (70) rotates due to running of the motor (66), whereby the belt (72) turns and the driven sprocket (74) and rear wheel (78) accordingly are rotated to propel the scooter forward. However, the following drawbacks are found with the prior art scooter:

(a) The driving sprocket becomes driven when the driven sprocket and rear wheel rotate at a speed faster than the motor can drive them, for example, when going down a steep hill.

(b) The belt is made of a rubber-like material which is inclined to slip from engagement with the driven sprocket when the load on the rear wheel is too great, such as going uphill or a rider is too heavy.

(c) The driving sprocket and shaft of the motor are not well supported and it is found that tension of the belt produces an uneven load on the bearings of the motor, as well as eventual loss of grip between the belt and the sprockets.

(d) The large driven sprocket has a diameter only slightly smaller than a diameter of the rear wheel and it is found that if the scooter is ridden over rough ground the driven sprocket can be damaged due to its closeness to the ground and rocks etc.

(e) The location of the motor at the front of the platform, whereby the belt extends substantially along the length of the platform to the rear wheel, means that too much space is occupied by the belt, and transmission power is lost due to the excessive length of the belt. Furthermore, the rider is exposed to the danger of a foot being caught in the belt.

Therefore, the invention provides a motorized foot scooter in which a motor drives in one direction to propel the scooter forward but is idle when a rear wheel rotates at a speed greater than possible or required via the driving sprocket to mitigate and/or obviate the aforementioned problem.

### SUMMARY OF THE INVENTION

The main objective of the present invention is to provide a motorized scooter with a large freewheel sprocket mounted on a motor axle whereby the motor is able to drive a rear wheel as well as be idle when a speed of the rear wheel exceeds a maximum output of the motor or the output of the motor is not required.

Another objective of the present invention is to provide a motorized scooter with a well supported motor and driving sprocket whereby a transmission chain is kept at a desired tension at all times and bearings of the motor are worn evenly.

Yet another objective of the present invention is to provide a motorized scooter with a raised foot area on which the rider can stand safely.

Yet another objective of the present invention is to provide small diameter driven sprocket mounted to the rear wheel whereby the driven sprocket is suitably disposed far from the ground such that it cannot be damaged by rocks etc.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a motorized scooter in accordance with the present invention;

FIG. 2 is a perspective view of a driving mechanism of the motorized scooter in accordance with the present invention; and

FIG. 3 is a perspective view of a prior art motorized scooter.

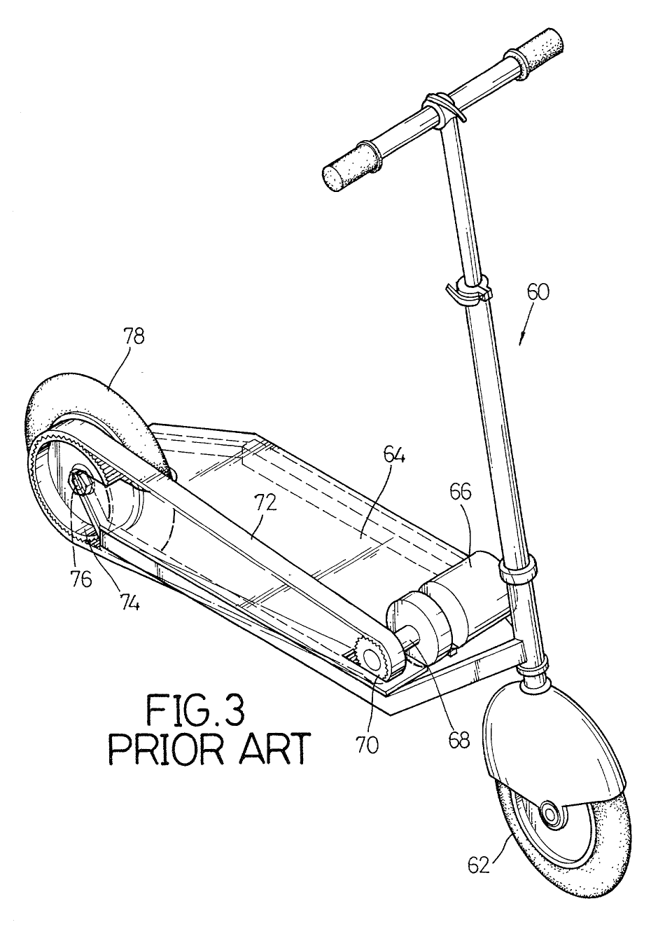

### DETAILED DESCRIPTION OF THE PREFERRED EMBODIMENT

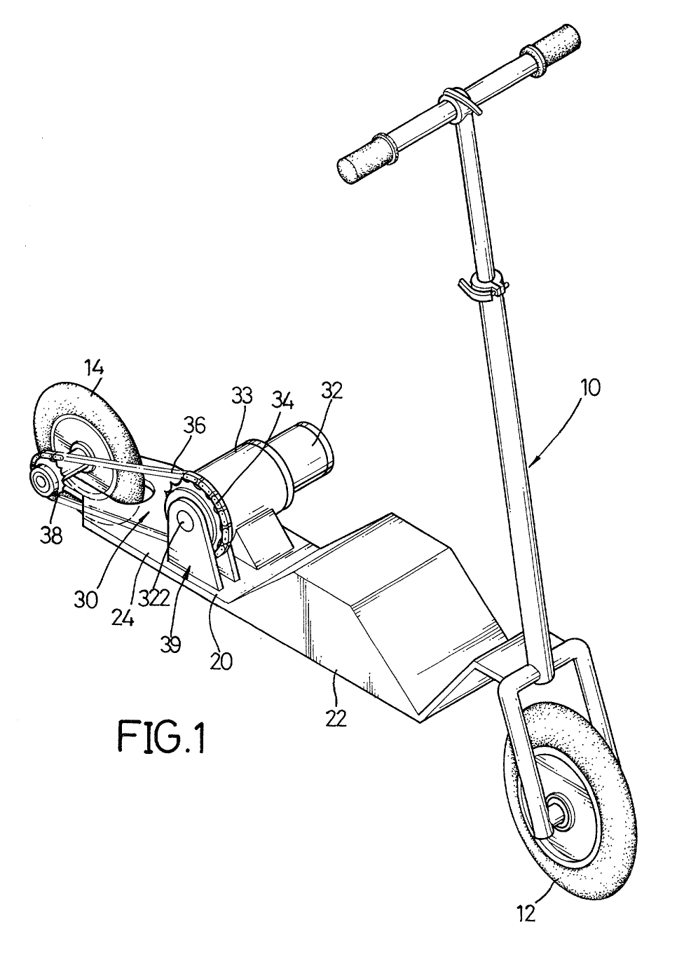

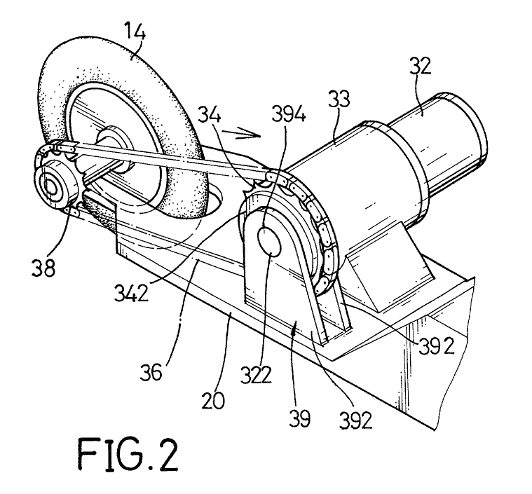

Referring to FIGS. 1 and 2, a motorized scooter in accordance with the present invention includes a steeing column (10), a platform (20), a front wheel (12), a rear wheel (14), a power train (30), and a motor (32).

Referring to FIG. 1, the steering column (10) is pivotally joined to a front of the platform (20) and has the front wheel (12) rotatably mounted to a bottom end thereof. The rear wheel (14) is rotably mounted to a rear of the platform (20). The platform (20) has a raised portion (22) formed between the front end and a middle part thereof, and a low portion (24) formed between the middle part and the rear end.

Referring to FIGS. 1 and 2, the power train (30) includes a large driving sprocket (34), a transmission chain (36), a small driven sprocket (38), and a bracket (39). A battery (not shown) actuates the motor (32) and can be housed in a compartment defined by the raised portion (22) of the platform (20) but as this is well known to those skilled in this field further description thereof is omitted. The motor (32) is transversely mounted on a top face of the low portion (24) of the platform (20), and has an axle (322) protruding from one end thereof. Optionally, a reduction mechanism (33) can be fitted between the motor (32) and the axle (322) to reduce a speed of the driving sprocket (34) and increase the torque thereof. The driving sprocket (34) is secured to the axle (322) and has a freewheel mechanism (342) such that in a driving mode the motor (32) turns the driving sprocket (34) in a first direction, but in a freewheel mode the driving sprocket (34) is free to rotate in a second direction independent of the motor (32). The bracket (39) is disposed adjacent to the axle end of the motor (32) and comprises two spaced-apart plates (392) each with a bottom end secured to the top face of the low portion (24) of the platform (20) by a conventional process such as welding, and a top distal end which defines a bore (394). The driving sprocket (34) is rotably received between the plates (392) of the bracket (39) and the axle (322) of the motor (32) extends through the bores (394) of the plates (392). The small driven sprocket (38) is drivingly secured to the rear wheel (14). The transmission chain (36) is reeved around the driving and driven sprockets (34, 38).

In operation, the axle (322) of the motor (32) rotates when powered in a conventional manner, whereby the driving sprocket (34) turns and accordingly the transmission chain (36), driven sprocket (38) and rear wheel (14) turn such that the scooter and rider standing thereon are propelled forward. When the scooter and rider travel downhill either at a speed faster than the motor (32) can provide or the power supply is temporarily interrupted, the freewheel mechanism (342) of the driving sprocket disengages the drive between the rear wheel and the motor.

The motorized scooter of the present invention has the following advantages:

(a) mechanical advantage. The useful life of the motor is long because of the disengagement ability between the rear wheel and the motor. Additionally, the bracket prevents uneven and premature wear of the bearings of the motor.

(b) power saving. The interruption of the running of the motor when the scooter travels downhill etc extends the life of the battery.

(c) safety. The raised portion of the platform and placement of the power train at the low portion of the platform each provides a safety feature to prevent injury to a rider's feet.

(d) performance. The rider can experience the thrill of traveling downhill at a speed faster than the motor can provide due to the disengagement ability between the rear wheel and the motor.

(e) low maintenance. The small diameter of the driven sprocket prevents damage thereto when the scooter is ridden over rough or rocky ground as the periphery of the sprocket is quite high above the ground.

(f) good power transmission. The chain provides an efficient transmission between the driving and driven sprockets. Furthermore, the bracket prevents movement of the motor axle and the driving sprocket towards the rear wheel thereby maintaining correct tension of the chain.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A motorized scooter with a platform, a steering column pivotally secured to a front end of the platform, a front wheel rotably mounted to a bottom end of the steering column, a rear wheel rotably secured to a rear end of the platform, and a motor actuated by a battery, wherein the improvements comprise:
a power train extending between the motor and the rear wheel, whereby in a driving mode the motor turns the power train in a first direction such that the scooter is propelled forward, and in a freewheel mode the rear wheel turns the power train in a second direction opposite to the first direction and the power train is disengaged from the motor.

2. The motorized scooter as claimed in claim 1, wherein the platform has a raised portion extending between the front end of the platform and a middle part of the platform.

3. The motorized scooter as claimed in claim 2, wherein the platform has a low portion extending between the middle part of the platform and the rear end of the platform.

4. The motorized scooter as claimed in claim 1, wherein the platform has a raised portion extending between the front end of the platform and a middle part of the platform, and a low portion extending between the middle part of the platform and the rear end of the platform.

5. The motorized scooter as claimed in claim 3, wherein the power train is mounted on the low portion of the platform.

6. The motorized scooter as claimed in claim 4, wherein the power train is mounted on the rear portion of the platform.

7. The motorized scooter as claimed in claim 1, wherein the power train comprises an axle protruding from the motor, a driving sprocket with a freewheel mechanism and mounted to the axle of the motor, a driven sprocket drivingly mounted to the rear wheel, and a chain reeved around the driven sprocket and the driving sprocket, wherein in the driving mode the freewheel mechanism provides engagement between the axle of the motor and the driving sprocket and in the freewheel mode the freewheel mechanism eliminates engagement between the axle of the motor and the driving sprocket.

8. The motorized scooter as claimed in claim 7, wherein the axle and the driven sprocket are supported by a bracket.

9. The motorized scooter as claimed in claim 8, wherein the bracket comprises two spaced-apart plates, each plate having a bottom end secured to the rear portion of the platform and a distal end defining a bore through which the axle extends and the driven sprocket is rotably received between the spaced-apart plates.

10. The motorized scooter as claimed in claim 7, wherein the driven sprocket has a diameter significantly bigger than a diameter of the driven sprocket.

11. The motorized scooter as claimed in claim 7, wherein the driven sprocket has a diameter significantly smaller than a diameter of the rear wheel.

12. The motorized scooter as claimed in claim 7, wherein a reduction mechanism is fitted between the motor and the axle.
